(19) United States
(12) Patent Application Publication
(10) Pub. No.: US 2005/0070248 A1
(43) Pub. Date: Mar. 31, 2005

(54) Method and system for maintaining media objects when switching mobile devices

(76) Inventor: Neeraj Gaur, Poway, CA (US)

Correspondence Address: Siemens Corporation;Attn: Elsa Keller, Legal Administrator, Intellectual Property Department, 170 Wood Avenue South, Iselin, NJ, 08830, US

(21) Appl. No.: 10/764,233

(22) Filed: Jan. 23, 2004

Related U.S. Application Data
(60) Provisional application No. 60/507,415, filed on Sep. 29, 2003.

(51) Int. Cl. H04M 1/66

(52) U.S. Cl. 455/410; 455/558

(57) ABSTRACT

The present invention is a method and system for transferring copy-protected content stored on a current mobile device to a new mobile device. Copy-protected content may be stored in an encrypted format in a storage unit of a mobile device. Decryption of the encrypted copy-protected content into the volatile memory (RAM) of the mobile device may only occur upon the detection of digital rights information stored in a removable data card within the mobile device. When the user wishes to purchase a new or different mobile device, the encrypted copy-protected content stored in the storage unit of the current mobile device may be transferred to a storage unit of a new mobile device. The encrypted copy-protected content that has been transferred to the new mobile device may only be decrypted upon transfer of the data card of the current mobile device to the new mobile device.

### CROSS-REFERENCE TO RELATED APPLICATION

This application claims priority from commonly-assigned provisional U.S. application No. 60/507,415 filed Sep. 29, 2003.

### BACKGROUND OF THE INVENTION

The present invention relates generally to a method and system for preventing illegal sharing of content, and particularly to a method and system for maintaining media objects when switching mobile devices.

Users of mobile devices, in an effort to obtain additional features for a mobile device, typically acquire content for use on a mobile device. Content may refer to media objects, logos, ringtones, games, Java applications and the like. Recently, digital rights management (DRM) mechanisms to secure copyright information and prevent illegal sharing and copying of content have been introduced. For example, the Open Mobile Alliance (OMA) has introduced a specification to prevent the unauthorized sharing or copying of content. Hereinafter “copy-protected content” is used to refer to that content for which protection against unauthorized copying/distributing is desired by content providers. Content providers desire to protect against unauthorized copying/distributing of copy-protected content, so that they may be capable of maximizing sales/licensing of content by restricting use of the content to only those who purchase and/or license the content.

A drawback associated with the use of DRM mechanisms with mobile device content is the restricted ability to upgrade the mobile device. A user who has purchased/licensed copy-protected content on his or her current mobile device may wish to obtain the additional benefits of the latest mobile device but does not want to purchase/license another copy of the copy-protected content that is already available on his or her current mobile device. For example, under the specification introduced by OMA, a user is prevented from switching to a different device as the OMA standard does not provide any mechanism to transfer the protected content purchased/licensed by the user residing in the current mobile device. Manufacturers of mobile devices may experience reduced sales of mobile devices because users who are considering the purchase of a new mobile device do not wish to re-purchase or re-license copy-protected content that is currently available on their current mobile device. Consequently, a method and system that allows users to transfer copy-protected content stored on a current mobile device to a new mobile device is desirable.

### SUMMARY OF THE INVENTION

Accordingly, the present invention is generally directed to a method and system for accessing copy-protected content stored on a current mobile device, along with transferring the copy-protected content to a new mobile device.

In an embodiment of the invention, copy-protected content is stored in an encrypted format in a nonvolatile storage unit of a mobile device. Decryption of the encrypted copy-protected content to the volatile memory of the mobile device may only be completed upon the retrieval of the digital rights information, referred to as a key, associated with the particular copy-protected content. The digital rights information may be stored in a removable data card within the mobile device. When the user wishes to purchase a new mobile device, the encrypted copy-protected content stored in the storage unit of the current mobile device may be transferred to a storage unit of a new mobile device. Advantageously, the encrypted copy-protected content that has been transferred to the new mobile device may only be decrypted upon transfer of the current mobile device's data card having the digital rights information to the new mobile device.

It is to be understood that both the foregoing general description and the following detailed description are exemplary and explanatory only and are not necessarily restrictive of the invention claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

FIG. 1 is an illustration depicting an embodiment of a system for maintaining copy-protected content in a current mobile device for a new mobile device in accordance with the present invention;

FIG. 2 is an illustration depicting an embodiment of a mobile device in accordance with the present invention;

FIGS. 3A and 3B are illustrations depicting an embodiment of a mobile device in the form of a mobile telephone employing a data card in accordance with the present invention;

FIG. 4 is a flow diagram illustrating an exemplary method of the present invention for providing copy-protected content;

FIG. 5 a flow diagram illustrating an alternative method 500 of the present invention for providing copy-protected content; and

FIG. 6 is a flow diagram illustrating an exemplary method of the present invention performed by a mobile device for transferring copy-protected content to another mobile device.

### DETAILED DESCRIPTION OF THE SPECIFIC EMBODIMENTS

Reference will now be made in detail to the presently preferred embodiments of the invention, examples of which are illustrated in the accompanying drawings.

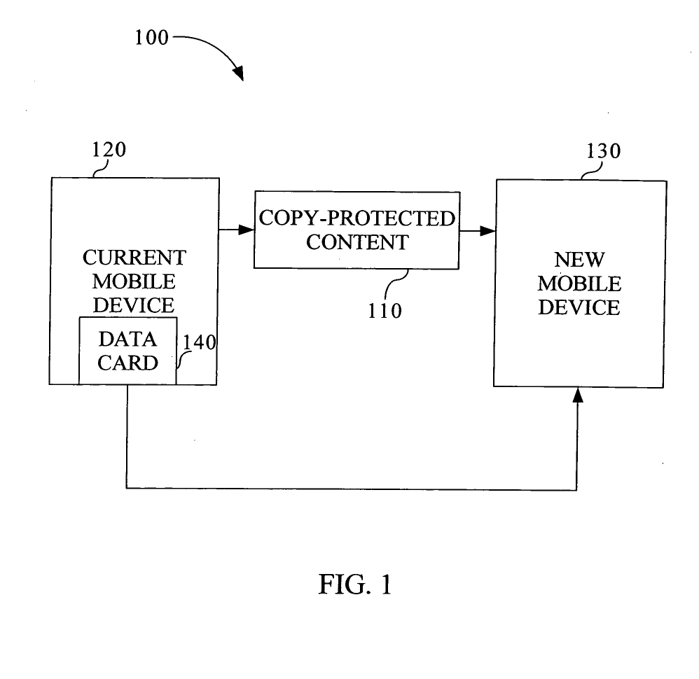

Referring generally to FIGS. 1 through 6, exemplary embodiments of the present invention are shown. According to a method and system of the present invention, copy-protected content on a current mobile device may be transferred to a new mobile device while maintaining protection of the copy-protected content as well as the authorized user's ability to use the copy-protected content. In an embodiment of the invention, copy-protected content, purchased and/or licensed from a content provider, may be stored in an encrypted format in a nonvolatile storage unit of a mobile device. Decryption of the encrypted copy-protected content to the volatile memory of the mobile device may only be executed upon the retrieval of digital rights information, referred to as a key. The digital rights information may be stored in a removable data card within the mobile device. When the user wishes to purchase a new mobile device, the encrypted copy-protected content stored in the storage unit of the current mobile device may be transferred to a permanent storage unit of a new mobile device. The encrypted copy-protected content that has been transferred to the new mobile device may only be decrypted upon transfer of the data card of the current mobile device to the new mobile device. Further, the encrypted copy-protected content stored on the new mobile device may not be re-utilized if the data card is removed or replaced with another data card that does not have the associated digital rights information.

Referring to FIG. 1, an illustration depicting an embodiment of a system 100 for maintaining copy-protected content 110 in a current mobile device 120 for a new mobile device 130 is shown. It is contemplated that copy-protected content may include ringtones, games, logos, applications and the like which employ a digital rights management (DRM) mechanism to prevent illegal sharing or copying. Copy-protected content may be stored in an encrypted format in a permanent storage unit and may only be decrypted to a volatile memory, such as random access memory (RAM), with proper decryption information, for example, digital rights information.

When a user purchases/licenses additional content for a mobile device, the content currently stored upon a computer or server of a content provider may be loaded into storage of a current mobile device 120 via a personal computer interface (e.g., serial cable, infrared or other wireless interface). Alternatively, an over-the-air (OTA) download over the air interface channel(s) of the mobile device may be employed by any mechanism described in the Open Mobile Alliance (OMA) DRM specifications, including Forward-Lock, Combined Delivery, or Separate Delivery. When loaded onto the mobile device, the copy-protected content is encrypted to prevent unauthorized copying or sharing. Additionally, a data card 140 stores the appropriate digital rights information (a decryption key) to allow decryption of the copy-protected content stored in an encrypted format within storage of the current mobile device 120.

When the user wishes to utilize a new mobile device 130, the encrypted copy-protected content 110 may be transferred from the current mobile device 120 to the new mobile device 130. Transfer of the encrypted copy-protected content may be implemented through removal of removable media storage from the current mobile device 120 into the new mobile device 130. Alternatively, transfer of the encrypted copy-protected content may be achieved through access via a personal computer interface and loading of the encrypted copy-protected content from the current mobile device 120 into the new mobile device 130. In an advantageous aspect of the present invention, decryption of the encrypted copy-protected content into volatile memory may only be effectuated with insertion of the data card 140 (having the associated digital rights information) into the new mobile device 130 utilized with the current mobile phone 120.

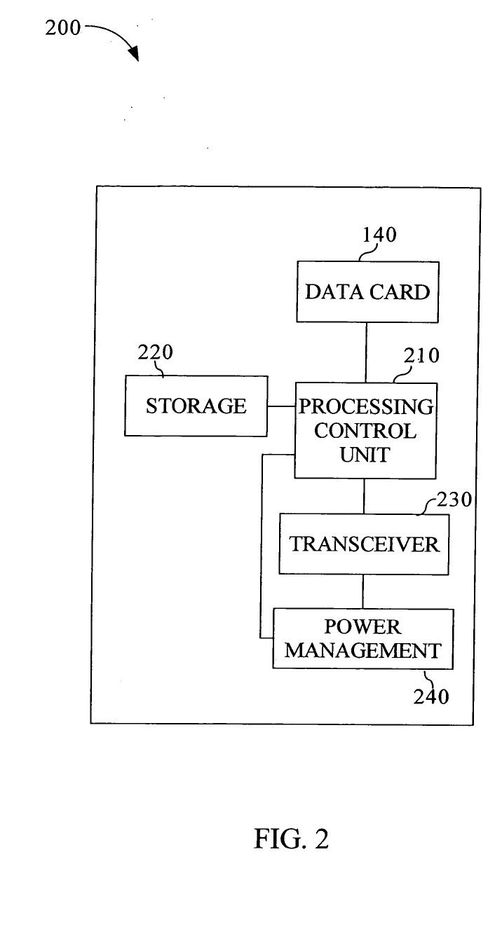

Referring now to FIG. 2, an illustration depicting an embodiment of a mobile device 200 in accordance with the present invention is shown. Mobile device 200 may be similar in structure and functionality as current mobile device 120 and new mobile device 130 as shown in FIG. 1. Mobile device 200 may include a processing control unit 210, storage 220, transceiver 230, power management 240 and a data card 140.

Processing control unit 210 may control the overall operation of the mobile device 200. A program of instructions for execution by the processing control unit 210 may be stored within storage 220. Storage 220 may include nonvolatile memory which may store the encrypted copy-protected content. It is contemplated that storage 220 may be in the form of flash memory or may be in the form of a removable media disk. Storage 220 may include volatile memory such as random access memory (RAM). Transceiver 230 may include circuitry to provide wireless connectivity capability. Power management 240 may include a battery and circuitry for recharging the battery that provides power for the processing control unit and transceiver along with the other components of the mobile device.

Data card 140 can be a subscriber identity module (SIM) card. In an alternative embodiment, data card 140 may be a removable user interface module (RUIM) card. A Global System for Mobile communication (GSM) handset product typically includes a SIM card which may store information about a subscriber's identity, a subscriber's rights, and the like. A future cell division multiple access (CDMA) terminal may include a RUIM card for storage of identity information and the like.

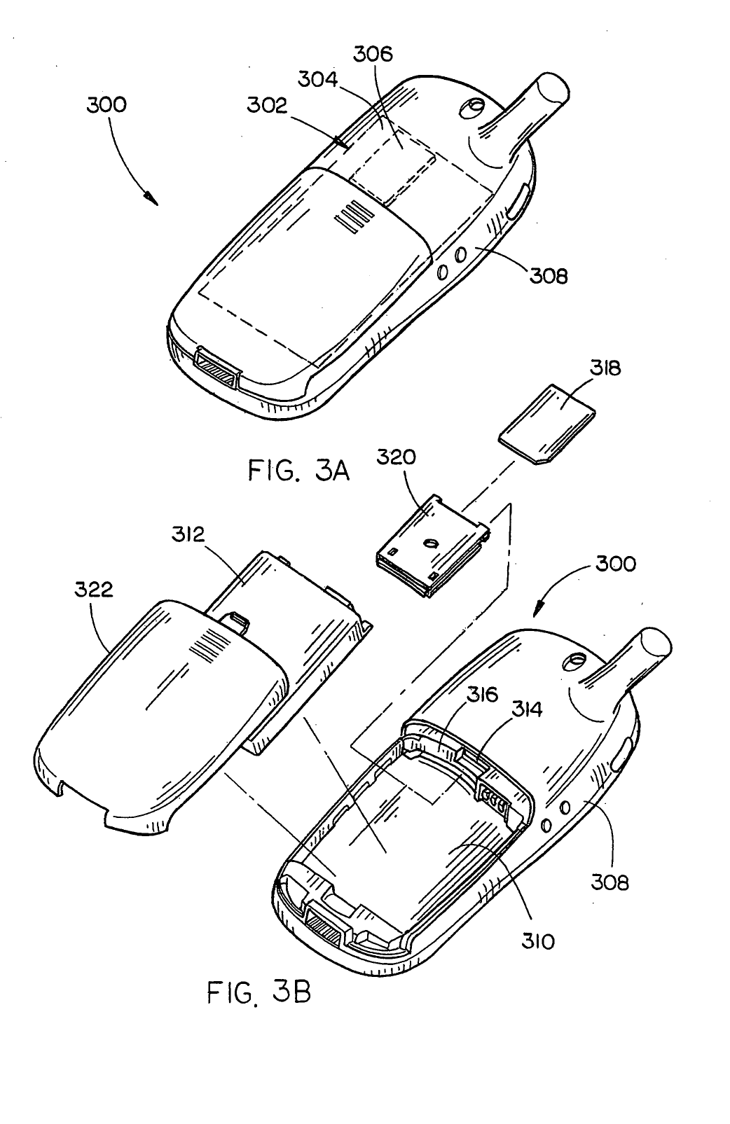

Referring to FIGS. 3A and 3B, illustrations depicting an embodiment of a mobile device in the form of a mobile telephone 300 employing a data card in accordance with the present invention are shown. Mobile telephone 300 is an exemplary type of mobile device 200 as shown in FIG. 2. The mobile telephone 300 may include a circuit board assembly 302 comprising a main printed circuit board 304 having a Y-axis elevated data card reader 306 for interfacing with the data card 318. The circuit board assembly 302 is enclosed within the mobile telephone housing 308, which includes a compartment 310 enclosing a power source such as a rechargeable battery 312, or the like, providing a source of electrical power to the mobile telephone 300. An aperture or slot 314 is formed in a wall 316 of the battery compartment 310 providing access to the data card reader 306 for insertion of a data card 318 such as a SIM card, RUIM card, or the like (a Y-axis SIM card reader and SIM card are illustrated).

The mobile telephone 300 further includes a data card holder 320 that supports the data card 318 during insertion and removal. During insertion, the data card 318 is first placed within the data card holder 320. Preferably, the data card 318 and data card holder 320 are configured so that insertion of the data card 318 into the data card holder 320 is intuitively obvious to the user. For example, as shown in FIG. 3B, the data card 318 may have a shape (e.g., a data card 318 having a clipped corner is shown) preventing incorrect insertion into the data card holder 320. The data card holder 320, containing the data card 318, is then inserted through the slot 314 in the battery compartment wall 316 so that the data card holder 320 and data card 318 are slid into the card receiving assembly of the elevated data card reader 306 along the Y-axis of the reader 306. The battery 312 may then be placed in the battery compartment 310, and a battery compartment cover 322 placed over the battery compartment 310 to enclose the battery 312. During removal, the battery compartment cover 322 and battery are removed. The data card holder 320 is slid from the slot 314 in the battery compartment wall 316 along the Y-axis of the data card reader 306, whereupon the data card 318 may be removed from the data card holder 320.

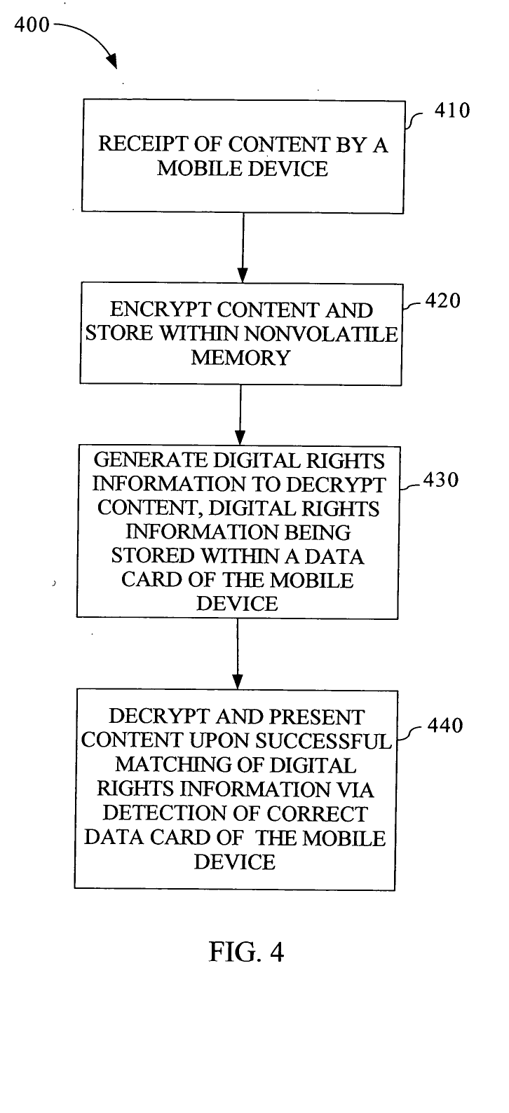

Referring to FIG. 4, FIG. a flow diagram illustrating an exemplary method 400 of the present invention for providing copy-protected content is shown. In an embodiment of the invention, method 400 may be executed by a mobile device manufacturer to prevent the unauthorized sharing and distributing of content. Method 400 may begin by receipt of content 410 by a mobile device. With conventional devices, since the content may not be encrypted, a user consequently may be able to re-utilize the content and transfer the content to another mobile device. In an embodiment of the invention, this type of transfer may be in accordance with the Forward-lock delivery of the OMA specification. To prevent the unauthorized sharing and distribution of the content from the mobile device, the content is encrypted locally by the mobile device and then stored within the nonvolatile memory of the mobile device. As a result, the encrypted content may only be provided upon the decryption of the copy-protected content stored in the nonvolatile memory of the current mobile device. Local digital rights information to decrypt the locally encrypted content may be generated in 430. The digital rights information (decryption information) may be stored within a data card of the mobile device. Decryption and presentation (e.g., viewing, listening, using, and/or accessing) of the encrypted content may only be effectuated upon successful matching of digital rights information via detection of the correct data card 440 storing the digital rights information associated with the particular content.

This is advantageous for the content provider because a user of a mobile device therefore does not have the ability to transfer the content to other users, thereby consequently causing other users to purchase/license the content themselves. Additionally, since the digital rights information may be embedded within the data card and stored in a secure location, the digital rights information cannot be transferred by the original user to others to thwart the copy-protection scheme without the original user losing the his own use of the data card.

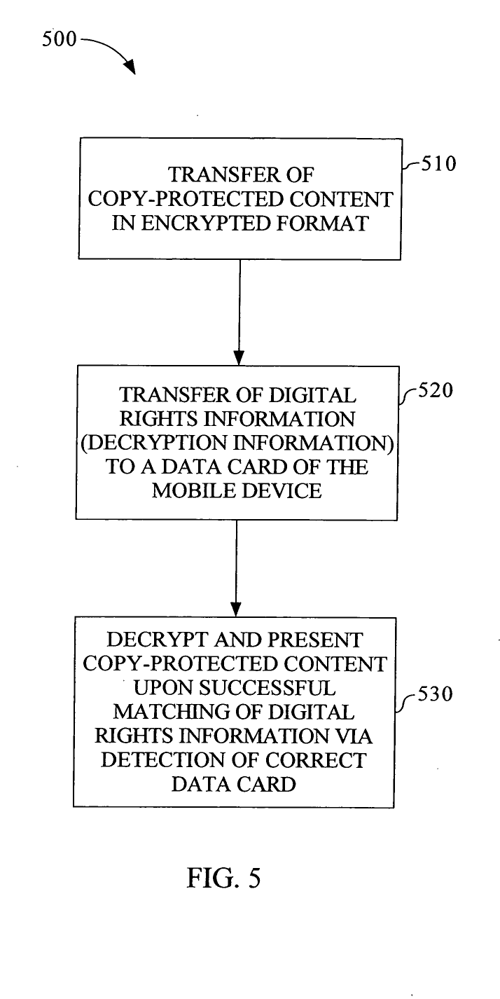

Referring to FIG. 5, a flow diagram illustrating an alternative method 500 of the present invention for providing copy-protected content is shown. In an embodiment of the invention, method 500 may be executed by a content provider to prevent the unauthorized sharing and distributing of content. The method 500 may begin upon the original, authorized transfer of copy-protected content 510. The copy-protected content is in an encrypted format and may be stored in a nonvolatile memory of the mobile device. In addition to the transfer of encrypted copy-protected content, digital rights information for decrypting the encrypted content may be transferred to the data card of the mobile device 520. In an embodiment of the invention, transfer of the encrypted copy-protected content 510 and digital rights information 520 may be in accordance with the combined and separate delivery protocols of the OMA specification. Decryption of the encrypted copy-protected content into volatile memory of the device (RAM) may only be completed upon the successful matching of digital rights information via the detection of the correct data card 530.

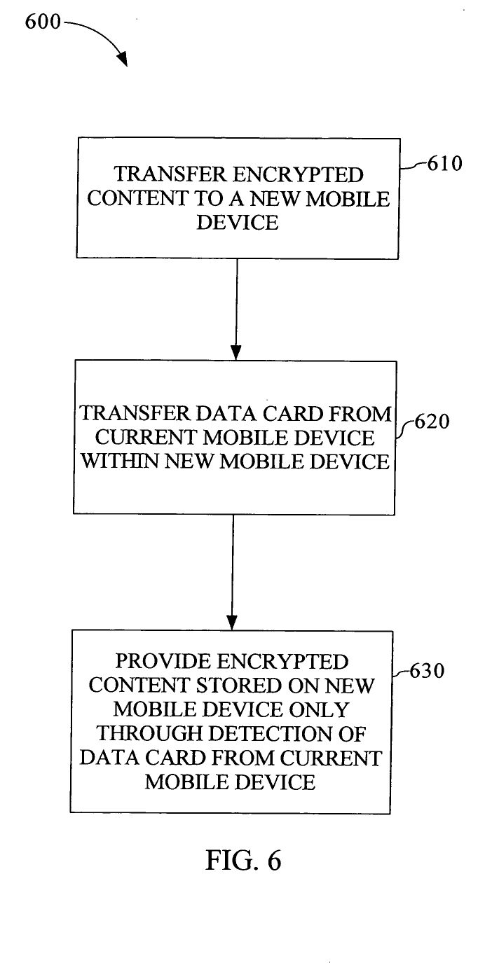

Referring now to FIG. 6, a flow diagram illustrating an exemplary method 600 of the present invention performed by a mobile device for transferring copy-protected content to another mobile device is shown. In an embodiment of the invention, method 600 may be executed by the system 100 for maintaining copy-protected content as shown in FIG. 1. A current mobile device may include copy-protected content that has been purchased/licensed (i.e., authorized) from a content provider, for example. Method 600 may be executed regardless of the method 400, 500 for retrieving the copy-protected content within the current mobile device. The copy-protected content stored in the current mobile device may be transferred in an encrypted format to a new mobile device 610. As stated previously, it is contemplated with the present invention that the encrypted copy-protected content may be transferred by removing a removable media disk or storage unit that stores the encrypted copy-protected content from the current mobile device to the new mobile device. Alternatively, the encrypted copy-protected content may be transferable through use of a personal computer interface or the like. Advantageously, the association between the digital rights information and encrypted content may be independent of the physical name of the content so that renaming the file of the content may not affect the association with the digital rights information.

The data card associated with the original receipt of the copy-protected content may be removed from the current mobile device and transferred to the new mobile device 620. In an embodiment of the invention, this may be completed by removing the data card from the data card receptacle of the current mobile device and inserting the same data card into the data card receptacle of the new mobile device. Advantageously, the data card may include the digital rights information for decrypting the encrypted copy-protected content that has been transferred to the new mobile device. Decryption of the encrypted copy-protected content transferred to the new mobile device may only be effectuated by the detection of the same data card that was present within the current mobile device 630.

While in one embodiment of the invention a mobile telephone is described as a type of mobile device, it is contemplated that the method and system of the present invention may operate with any type of mobile device including a personal digital assistant (PDA), a mobile handset, a mobile telephone, a pager, and the like without departing from the scope and intent of the present invention.

Although the invention has been described with a certain degree of particularity, it should be recognized that elements thereof may be altered by persons skilled in the art without departing from the scope and spirit of the invention. It is understood that the specific orders or hierarchies of steps in the methods illustrated are examples of exemplary approaches. Based upon design preferences, it is understood that the specific orders or hierarchies of these methods can be rearranged while remaining within the scope of the present invention. The accompanying method claims present elements of the various steps of methods in a sample order, and are not necessarily meant to be limited to the specific order or hierarchy presented.

It is believed that the scope of the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

1. A method for providing authorized access of copy-protected content to an authorized user of a mobile device, comprising:
receiving content;
encrypting said content, said encrypted content being stored in memory of a mobile device;
generating decryption information for said encrypted content; said decryption information being stored within specific removable data card within said mobile device; and
providing said unencrypted content upon said mobile device when said specific removable data card containing decryption information for said encrypted content is detected within said mobile device.

2. The method as described in claim 1, further comprising preventing decryption of said encrypted content when a different removable data card is inserted within said mobile device.

3. The method as described in claim 1, wherein decryption information of said encrypted content is stored in a secure location of said specific removable data card.

4. The method as described in claim 1, said specific removable data card being at least one of a subscriber identity module card and a removable user interface module card.

5. A method of providing copy-protected content to a mobile device, comprising:
transferring content to a mobile device, said content being in an encrypted format;
transferring digital rights information for decrypting the content to said mobile device, said digital rights information being stored within a specific removable data card within said mobile device; and
wherein the content in said encrypted format is able to be decrypted upon the detection of the specific removable data card containing said digital rights information.

6. The method as described in claim 5, wherein the content is not able to be decrypted when a different removable data card is inserted within said mobile device.

7. The method as described in claim 5, wherein said digital rights information for decrypting content is stored in a secure location of said specific removable data card.

8. The method as described in claim 5, wherein the mobile device is a mobile telephone.

9. The method as described in claim 8, wherein said removable data card is at least one of a subscriber identity module card and a removable user interface module card.

10. The method as described in claim 5, wherein said content transferring step comprises downloading said content over-the-air or downloading said content via a computer coupled to said mobile device.

11. A method, in a system including a first mobile device and a second mobile device, for maintaining copy-protected content, comprising:
transferring encrypted content stored within said first mobile device to said second mobile device;
transferring a specific removable data card including digital rights information associated with said first mobile device to a receptacle of said second mobile device; and
decrypting said encrypted content transferred from said first mobile device on said second mobile device when said specific removable data card including said digital rights information has been detected within said second mobile device.

12. The method as described in claim 11, further comprising preventing decryption of said content when another removable data card is detected within said second mobile device.

13. The method as described in claim 11, wherein transferring encrypted content includes removing a removable media disk storing encrypted content from said first mobile device and inserting the removable media disk into the second mobile device.

14. The method as described in claim 11, wherein the mobile device is a mobile telephone, a mobile handset, a personal digital assistant (PDA), or pager.

15. The method as described in claim 11, wherein said specific removable data card is at least one of a subscriber identity module card and a removable user interface module card.

16. A method, in a system including a first mobile device and a second mobile device, for maintaining copy-protected content, comprising:
transferring encrypted content stored within said first mobile device to said second mobile device; and
transferring a specific removable data card including digital rights information associated with said first mobile device into a receptacle of said second mobile device, whereby encrypted content transferred from said first mobile device is decrypted on said second mobile device when said specific removable data card including said digital rights information has been detected within said second mobile device.

17. The method as described in claim 16, further comprising preventing decryption of said content when a different removable data card is detected within said second mobile device.

18. The method as described in claim 16, wherein transferring encrypted content includes removing a removable media disk storing said encrypted content from said first mobile device and inserting the removable media disk into the second mobile device.

19. The method as described in claim 16, wherein the mobile device is a mobile telephone, a mobile handset, a personal digital assistant (PDA), or pager.

20. The method as described in claim 16, wherein said specific removable data card is at least one of a subscriber identity module card and a removable user interface module card.
